(19) United States
(12) Patent Application Publication
(10) Pub. No.: US 2022/0224515 A1
(43) Pub. Date: Jul. 14, 2022

(54) MULTI-PARTY COMPUTATION (MPC) BASED KEY SEARCH IN PRIVATE DATA

(71) Applicant: NEC Corporation Of America, Herzlia (IL)

(72) Inventors: Ori YAMPOLSKY, Herzliya (IL); Maya COHEN MAIMON, Safed (IL); Tsvi LEV, Tel-Aviv (IL); Yaacov HOCH, Ramat-Gan (IL); Ekaterina SHELENKOVA, Netanya (IL)

(73) Assignee: NEC Corporation Of America, Herzlia (IL)

(21) Appl. No.: 17/145,349

(22) Filed: Jan. 10, 2021

(51) Int. Cl. H04L 9/08; H04L 9/32; G06F 16/245; G06F 7/76; G06F 7/491

(52) U.S. Cl. CPC H04L 9/085; H04L 9/3215; H04L 2209/46; G06F 7/76; G06F 7/4915; G06F 16/245

(57) ABSTRACT

Disclosed herein are methods and systems for efficiently retrieving data from an at least partially encrypted table based record using secure Multi-Party Computation (MPC). A query received to retrieve data from a table based record comprising data items arranged in rows and columns may include a queried data item (key) which potentially matches one or more encrypted data items contained in one or more of the columns. The computing nodes, each having a respective one of a plurality of shares of a one-hot representation of each of the encrypted data items engage in the MPC session to match between a one-hot representation of the queried data item and the one-hot representation of each encrypted data item and output each matching row. The match is based on multiplying, in each encrypted data item's one-hot representation, only bits identified as hot in the queried data item's one-hot representation.

### FIELD AND BACKGROUND OF THE INVENTION

The present invention, in some embodiments thereof, relates to retrieving data from a table based record comprising at least some private encrypted data, and, more specifically, but not exclusively, to employing secure MPC for efficiently retrieving data from a table based record comprising at least some private encrypted data.

Data and information technologies play a major and ever growing part in modern times and are constantly evolving and expanding in unprecedented pace into a plurality of diverse applications, services, platforms, infrastructures and/or the like forming present day economics, government services and/or the like.

The data which is therefore one of the most important assets available to companies, organizations, government institutions and/or the like may be typically stored in large capacity data structures, for example, databases, data centers and/or the like. Due to the need for high data availability, advanced technologies, structures and architectures were developed over the years to support easy, simple and/or fast retrieval of data from these data structures.

However, while data availability and accessibility is highly important, at least some of this data may be private data, for example, personal information, financial data, trade secrets and/or the like which is highly sensitive and must be therefore strictly maintained and handled. Data privacy is therefore a major concern and extensive efforts are constantly invested in developing and deploying security measures to ensure privacy, security and safety of the stored private data.

### SUMMARY OF THE INVENTION

According to a first aspect of the present invention there is provided a method of efficiently retrieving data from an at least partially encrypted table based record using secure Multi-Party Computation (MPC), comprising using a plurality of networked computing nodes each comprising one or more processors configured for:
Receiving a query to retrieve data from a table based record comprising a plurality of data items arranged in a plurality of rows and a plurality of columns. One or more of the plurality of columns containing a plurality of encrypted data items. The query comprising a data item, in decrypted form, which potentially matches one or more of the plurality of encrypted data items.
Engaging in a secure MPC session with at least some of the plurality of networked computing nodes, each having a respective one of a plurality of shares of a one-hot representation of each of the encrypted data items, to match between a one-hot representation of the queried data item and the one-hot representation of each encrypted data item.
Outputting an identifier of each row comprising a matching encrypted data item.
   Wherein the MPC match is based on multiplying, in the one-hot representation of each encrypted data item, only bits which are identified as hot bits in the one-hot representation of the queried data item thus significantly reducing the match time.

According to a second aspect of the present invention there is provided a system for efficiently retrieving data from an at least partially encrypted table based record using secure Multi-Party Computation (MPC), comprising a plurality of networked computing nodes, each of the plurality of networked computing nodes comprising one or more processors. The one or more processors are configured to execute a code. The code comprising:
Code instructions to receive a query to retrieve data from a table based record comprising a plurality of data items arranged in a plurality of rows and a plurality of columns. One or more of the plurality of columns containing a plurality of encrypted data items. The query comprising a data item, in decrypted form, which potentially matches one or more of the plurality of encrypted data items.
Code instructions to engage in a secure MPC session with at least some of the plurality of networked computing nodes, each having a respective one of a plurality of shares of a one-hot representation of each of the encrypted data items, to match between a one-hot representation of the queried data item and the one-hot representation of each encrypted data item.
Code instructions to output an identifier of each row comprising a matching encrypted data item
   Wherein the MPC match is based on multiplying in the one-hot representation of each encrypted data item only bits which are identified as hot bits in the one-hot representation of the queried data item thus significantly reducing the match time.

According to a third aspect of the present invention there is provided a computer program product comprising program instructions executable by a computer, which, when executed by the computer, cause the computer to perform a method according to the first aspect.

According to a fourth aspect of the present invention there is provided a method of efficiently retrieving data from an at least partially encrypted table based record using secure Multi-Party Computation (MPC), comprising using a plurality of networked computing nodes each comprising one or more processors configured for:
Receiving a query to retrieve data from a table based record comprising a plurality of data items arranged in a plurality of rows and a plurality of columns, one or more of the plurality of columns containing a plurality of encrypted data items, the query comprising an encrypted one-hot representation of a queried data item which potentially matches one or more of the plurality of encrypted data items.
Engaging in a secure MPC session with at least some of the plurality of networked computing nodes, each having a respective one of a plurality of shares of an encrypted one-hot representation of each of the encrypted data items, to match between the encrypted one-hot representation of the queried data item and the encrypted one-hot representation of each encrypted data item by:
   Computing a dot product for each of a plurality of digits of the encrypted one-hot representation of the queried data item and the encrypted one-hot representation of each encrypted data item.
   Aggregating the dot products computed for the plurality of digits.
   Identifying each row comprising a matching encrypted data item for which an outcome of the aggregation is one.
Outputting an identifier of each matching row.
   Wherein computing the dot product is based on arranging all bits of the encrypted one-hot representation of the queried data item in a first sequence and the arranging all bits of the encrypted one-hot representation of each encrypted data item in a respective second sequence and applying a single AND operation between the first sequence and each second sequence thus significantly reducing the match time.

According to a fifth aspect of the present invention there is provided a system for efficiently retrieving data from an at least partially encrypted table based record using secure Multi-Party Computation (MPC), comprising a plurality of networked computing nodes, each of the plurality of networked computing nodes comprising one or more processors. The one or more processors are configured to execute a code. The code comprising:
Code instructions to receive a query to retrieve data from a table based record comprising a plurality of data items arranged in a plurality of rows and a plurality of columns. One or more of the plurality of columns containing a plurality of encrypted data items. The query comprising an encrypted one-hot representation of a queried data item which potentially matches one or more of the plurality of encrypted data items.
Code instructions to engage in a secure MPC session with at least some of the plurality of networked computing nodes, each having a respective one of a plurality of shares of an encrypted one-hot representation of each of the encrypted data items, to match between the encrypted one-hot representation of the queried data item and the encrypted one-hot representation of each encrypted data item by:
   Computing a dot product for each of a plurality of digits of the encrypted one-hot representation of the queried data item and the encrypted one-hot representation of each encrypted data item.
   Aggregating the dot products computed for the plurality of digits.
   Identifying each row comprising a matching encrypted data item for which an outcome of the aggregation is one.
Code instructions to output an identifier of an identifier of each matching row.
   Wherein computing the dot product is based on arranging all bits of the encrypted one-hot representation of the queried data item in a first sequence and the arranging all bits of the encrypted one-hot representation of each encrypted data item in a respective second sequence and applying a single AND operation between the first sequence and each second sequence thus significantly reducing the match time.

According to a sixth aspect of the present invention there is provided a computer program product comprising program instructions executable by a computer, which, when executed by the computer, cause the computer to perform a method according to the fourth aspect.

In a further implementation form of the first, second and/or third aspects, for each encrypted data item, a multiplication outcome of “one” (“1”) indicates the respective encrypted data item matches the queried data item and a multiplication outcome of “zero” (“0”) indicates the respective encrypted data item does not match the queried data item.

In an optional implementation form of the first, second, third, fourth, fifth and/or sixth aspects, respective pairs of bits in the one-hot representation of one or more of the encrypted data items are simultaneously multiplied.

In an optional implementation form of the first, second, third, fourth, fifth and/or sixth aspects, the rows are sorted according to values of non-encrypted data items contained in one or more of the plurality of columns.

In a further implementation form of the first, second, third, fourth, fifth and/or sixth aspects, the one-hot representation is based on a decimal representation of the respective data item.

In a further implementation form of the first, second, third, fourth, fifth and/or sixth aspects, the one-hot representation is based on a hexadecimal representation of the respective data item.

In a further implementation form of the first, second, third, fourth, fifth and/or sixth aspects, the one-hot representation is set according to a word size defined by an instruction set architecture of one or more of the processors.

In a further implementation form of the first, second, third, fourth, fifth and/or sixth aspects, the secure MPC session is executed over secure communication channels established between the at least some networked computing nodes.

In a further implementation form of the first, second, third, fourth, fifth and/or sixth aspects, the secure communication channels are established using one or more encryption protocols used for encrypting the data exchanged between the at least some networked computing nodes.

In a further implementation form of the first, second, third, fourth, fifth and/or sixth aspects, the plurality of networked computing nodes are independent of each other such that each of the plurality of networked computing nodes is controlled by a respective party.

In a further implementation form of the first, second, third, fourth, fifth and/or sixth aspects, the secure MPC session is executed by the plurality of networked computing nodes according to one or more MPC protocols based on one or more secret sharing algorithms used to create the plurality of shares of the one-hot representation of each of the encrypted data items.

In an optional implementation form of the first, second, third, fourth, fifth and/or sixth aspects, one or more of the MPC protocols define a subset of the plurality of networked computing nodes comprising a sufficient number of networked computing nodes for matching the queried data item using their respective shares.

In a further implementation form of the fourth, fifth and/or sixth aspects, the dot product is computed for each digit of each encrypted data item by multiplying respective bits of the respective digit in the encrypted one-hot representation of the queried data item and the respective bits in the encrypted one-hot representation of the respective encrypted data item.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of efficiently retrieving data from a table comprising at least some private encrypted data using a plurality of computing nodes engaged in a secure MPC, according to some embodiments of the present invention;

FIG. 2 is a schematic illustration of an exemplary system for efficiently retrieving data from a table comprising at least some private encrypted data using a plurality of computing nodes engaged in a secure MPC, according to some embodiments of the present invention;

FIG. 3 is a schematic illustration of an exemplary one-hot representation of data values, according to some embodiments of the present invention;

FIG. 4 is a schematic illustration of an exemplary one-hot representation of an exemplary data value split to a plurality of shares distributed to a plurality of networked computing nodes, according to some embodiments of the present invention;

FIG. 5 is a schematic illustration of a sequence for multiplying hot bits of an exemplary one-hot representation for matching an encrypted one-hot representation of a data value by a plurality of networked computing nodes using their respective shares, according to some embodiments of the present invention;

FIG. 6 is a schematic illustration of a sequence for simultaneously multiplying hot bits of an exemplary one-hot representation for matching an encrypted one-hot representation of a data value by a plurality of networked computing nodes using their respective shares, according to some embodiments of the present invention; and

FIG. 7 is a flowchart of an exemplary process of efficiently retrieving data from a table comprising at least some private encrypted data using a plurality of computing nodes engaged in a secure MPC according to an encrypted queried data item, according to some embodiments of the present invention.

### DESCRIPTION OF SPECIFIC EMBODIMENTS OF THE INVENTION

The present invention, in some embodiments thereof, relates to retrieving data from a table based record comprising at least some private encrypted data, and, more specifically, but not exclusively, to employing secure MPC for efficiently retrieving data from a table based record comprising at least some private encrypted data.

According to some embodiments of the present invention, there are provided methods, systems, devices and computer program products for retrieving data from one or more table based records, for example, a database, a file, a list and/or the like which contains private data.

The table based record may be constructed of a plurality of cells arranged in a plurality of rows and columns where each of the columns corresponds to a respective property of the data stored in the table based record. Some of the columns may correspond to properties which are not private and the cells in these columns may therefore include data items which are not considered private. However, one or more of the columns may correspond to properties which are private and the cells of these columns may therefore include data items which are private. For example, assuming the table based record contains data relating to financial and/or trade transactions made by a plurality of clients, users and/or traders (collectively designated users hereinafter). In such table based record, the cells of one or more columns corresponding to private properties, for example, a user name, a user identifier (ID) and/or the like may contain private data items. However, the cells of one or more other columns may correspond to other properties which are regarded as non-private data, for example, transaction amount, a transaction type (e.g. credit/debit), a transaction time and/or the like may therefore contain non-private data items.

Therefore, in order to ensure privacy, security and/or safety of the private data, the private data items may be encrypted by splitting (dividing) each of the data items to a plurality of shares which may be distributed to a plurality of the computing nodes. The splitting may be done using one or more encoding functions, for example, a XOR function, an addition modulo function and/or the like. As such, each of the computing nodes has access only to its respective share of each encrypted data item and none of the computing nodes is therefore able to individually reconstruct the encrypted data items.

The computing nodes forming a networked community may be typically controlled by different parties, for example, a private entity, a commercial entity (e.g. bank, stock exchange, company, organization, etc.), an institution (e.g. regulatory agency, government office, etc.) and/or the like such that the computing nodes are independent from each other.

In order to support fast and efficient key matching while searching in the table based record, each of the encrypted data items may represented by a respective one-hot representation according to one or more bases. This means that the one-hot representation of each of the private data items (interchangeably designated encrypted data items) is encrypted by splitting each one-hot representation to the plurality of shares distributed between the plurality of computing nodes. In the one-hot representation, as known in the art, a value may be represented by a single bit set (“1”) in only one of the positions of each digit while all other positions are cleared (“0”). The same one-hot representation is repeated in each power (digit).

The base selected to create the one-hot representations of the encrypted data items may be defined, set and/or selected according to one or more criteria, conditions, and/or operational parameters. For example, the base selected for creating the one-hot representations of one or more of the encrypted data items may be decimal base, hexadecimal base and/or the like. The base may be further selected according to one or more operational parameters of the computing nodes, for example, according to an Instruction Set Architecture (ISA) of the processor(s) of the computing nodes, for example, 256, 65536 and/or the like.

The one-hot representation of each of the encrypted data items may be divided between the plurality of computing nodes of the community. In particular, the bit value, i.e., “1” or “0” of each position (bit) of each row (digit) of the one-hot representation of each encrypted data item is encrypted and split to a plurality of shares which are distributed among the plurality of computing nodes such that the computing nodes have direct access to the respective share of each position in the one-hot representation of each encrypted data item.

Due to the provisions made in the table based record, specifically the encrypted one-hot representations created for each of the encrypted private data items, the community of computing nodes may quickly and efficiently retrieve data from the table based record in response to queries, specifically queries targeting the encrypted data items.

Such queries, targeting the encrypted data items, may define (include) one or more (queried) data items serving as keys which may potentially match one or more of the encrypted data items contained in one or more of the columns corresponding to private properties. However, while targeting the encrypted data items, the queried data item(s) is not encrypted but is rather received in decrypted form.

After receiving the query, the computing nodes may first generate a one-hot representation of the queried data item(s) according to the base applied in the table based record. The computing nodes may then engage in one or more secure MPC sessions using one or more MPC algorithms and/or protocols as known in the art to search for a match between the encrypted data items targeted by the queried data item(s) and the queried data item(s).

In particular, the computing nodes may engage in the secure MPC session(s) using their respective shares of the encrypted data items targeted by the queried data item(s) to match between the one-hot representation of the queried data item(s) and the one-hot representation of each of the targeted encrypted data items. The matching is done by multiplying the bit positions in the one-hot representations of the encrypted data items which are identified as hot bits (bits set to “1”) in the one-hot representation of the queried data item(s). The one-hot representation is a one-to-one mapping and each data value is therefore represented by a unique one-hot presentation. Therefore, in case the outcome of the multiplication is one (“1”) for a respective encrypted data item, the respective encrypted data item may match the queried data item since the bits of the one-hot representation of the respective encrypted data item at the positions identified as hot are all set (“1”). However, in case even one of the bits in a respective encrypted data item at the positions identified as hot is cleared (“0”), the multiplication outcome may be zero (“0”) thus indicating that the respective encrypted data item does not match the queried data item.

Optionally, since the bits at different positions of the one-hot representations of the encrypted data items are independent of each other, the computing nodes may engage in the secure MPC session to simultaneously multiply pairs of bits in the encrypted one-hot representation of one or more of the encrypted data item such that a plurality of pairs of bits are multiplied and computed in parallel.

After traversing all rows of the table based record in search for matching encrypted data items, the computing nodes may output an indication of each row which comprises encrypted data item(s) matching the queried data item(s). The indication may include an identifier (ID) of each matching row, for example, row number. However, the indication may further include the data contained in each matching row and/or part thereof.

Optionally, the rows of the table based record may be sorted according to one or more sorting rules based on the data items which are not encrypted, i.e. non-private data items contained in one or more of the columns corresponding to non-private properties of the stored data.

Optionally, only a subset of the computing nodes may engage in the secure MPC session(s) to search for a match between the encrypted data items targeted by the queried data item(s) and the queried data item(s). Specifically, the subset of computing nodes may use one or more threshold MPC protocols as known in the art which define a minimum number of computing nodes which is sufficient for engaging in the secure MPC session(s) to successfully reconstruct the encrypted one-hot representations of the encrypted data items and multiply their bits in the hot positions without the need for all of the computing nodes to participate in the secure MPC session(s).

The secure MPC based data retrieval from the table based record may present major benefits and advantages compared to existing methods for accessing, searching and retrieving data from table based records.

First, the private data items contained in the table based record are encrypted to reduce accessibility to the private data thus significantly increasing privacy, security and/or safety of the private data. Furthermore, the encrypted private data items are split and distributed among the plurality of computing nodes such that no single computing node may have access to the any complete encrypted private data item. Since the computing nodes controlled by different parties may be independent of each other, the computing nodes may be significantly protected and secure against malicious attack and/or exploitation initiated in attempt to compromise the computing nodes in order to gain access to the private data.

Moreover, the existing methods in which some of the data items are encrypted may be based on comparing between the entire queried data item(s) (key) and each of the encrypted data items. This approach may be highly limited since it may require extensive computing resources (processing resources, storage resources, etc.) and may significantly prolong the search time since large amounts of data need to be compared.

These limitations are further increased in case the encrypted data items are split and distributed among a plurality of computing nodes to further increase their security since the MPC algorithms and/or protocols may require the computing nodes to invest extended computing resources as well as significant networking resources. In contrast, representing the encrypted data items in the one-hot representation, as described in the present invention, may significantly reduce the search and match time for identifying encrypted data items matching the queried data item(s), i.e., the search key. This is because in the on-hot representation each digit in each power is expressed by a single hot bit (“1”) while all other bits are clear (“0”). The computing nodes may therefore engage in the secure MPC session to multiply, in the one-hot representation of each encrypted data item, only bits at positions identified as hot bits in the one-hot representation of the queried data item(s).

Furthermore, since the bits in the one-hot representations of the encrypted data items are independent of each other, pairs of bits may be multiplied simultaneously at the same time thus further reducing the search and match time for identifying matching encrypted data items.

In addition, enabling only a subset of the computing nodes to engage in the secure MPC session(S) without the need for all of the computing nodes to participate may significantly increase robustness of the secure MPC session(s) since scenarios in which at least some of the computing nodes are unavailable (e.g. offline, disconnected, etc.) may be easily overcome.

Also, the one-hot representation of the encrypted data items is non conflicting with the other data items contained in the table based record which are not encrypted. The rows in the table based record may be therefore sorted and/or arranged based on the values of the non-encrypted data items without affecting the ability of the computing nodes to search for encrypted data items matching the queried data item(s).

According to some embodiments of the present invention, the query for retrieving data from the table based record may include one or more encrypted queried data items serving as keys to search for matching encrypted data items in one or more of the columns of the table based record. In particular, the query may include one or more encrypted one-hot representations of the queried data items. The computing nodes may engage in one or more secure MPC sessions to match between the encrypted one-hot representation(s) of the queried data item(s) and the encrypted one-hot representation of each of the encrypted data items targeted in the table based record.

The matching is based on computing a dot product for each digit of the one-hot representation of the queried data item and the one-hot representation of each of the encrypted data items by multiplying respective bits in each position of the respective digit. The outcomes (results) of the multiplications may be aggregated (e.g. added, summed, combined, etc.) to produce the dot product for the respective digit. This may be repeated for all digits followed by aggregating the dot products computed for all digits. A value of one (“1”) of the outcome of the aggregated dot products may indicate that the encrypted one-hot representation of the respective encrypted data item matches the encrypted one-hot representation of the encrypted queried data item. A value of zero (“0”) on the other hand may indicate that the encrypted one-hot representation of the respective encrypted data item does not match the encrypted one-hot representation of the encrypted queried data item.

In particular, all bits of each digit of the encrypted one-hot representation of the queried data item may be arranged in a first sequence, for example, a long integer value (e.g. for base 64). Similarly, all bits of the respective digit in the encrypted one-hot representation of the respective encrypted data item may be arranged in a second sequence constructed as the first sequence. The computing nodes may then apply a single AND operation between the first sequence and the second sequence to compute the dot product of the respective digit.

Applying the single AND operation for computing the dot products for the digits may significantly reduce the computation time and thus the overall match time compared to existing MPC based matching methods in which the encrypted data items are not expressed by encrypted one-hot representations. Since the encrypted data items are not expressed by respective encrypted one-hot representations, these existing methods may need to apply multiple typically complicated algebraic and/or logic operations which are highly computing intensive.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

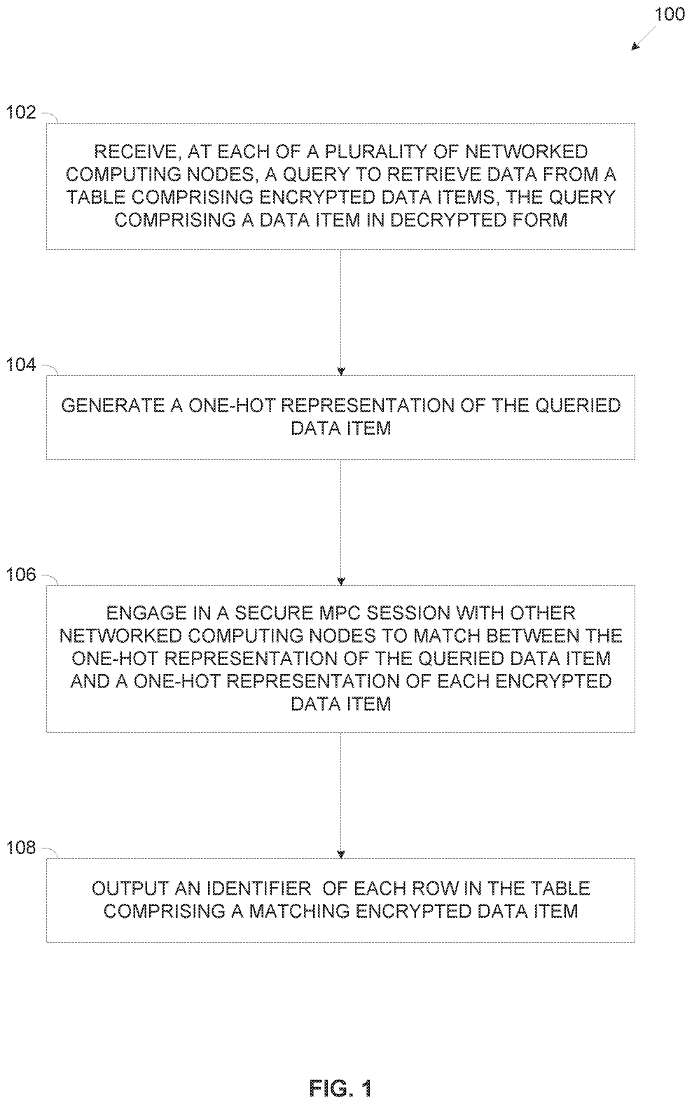

Referring now to the drawings, FIG. 1 illustrates a flowchart of an exemplary process of efficiently retrieving data from a table comprising at least some private encrypted data using a plurality of computing nodes engaged in a secure MPC, according to some embodiments of the present invention.

An exemplary process 100 may be executed by each of a plurality of networked computing nodes which are typically independent of each other to engage in an MPC to jointly search for receiving one or more queried data items serving as match keys and matching encrypted data items stored in a table based record, for example, a database, a file, a list and/or the like to identify matching rows comprising encrypted data item(s) matching the queried data item(s).

The table based record may include at least some private data items which are each represented in a one-hot representation. The one-hot representation of each of the private data items may be encrypted by splitting each private data item to a plurality of shares each stored and accessible by a respective one of the computing nodes.

The computing nodes may receive a queried data value, in decrypted form, for matching against the encrypted data items in each of the rows. The computing nodes may generate a one-hot representation of the queried data item and may engage in a secure MPC using their respective shares to check for match between the one-hot representation of the queried data item and the one-hot representation of each of the encrypted data items.

The computing nodes may further output an identifier, for example, a row number, of each row comprising a decrypted data item matching the queried data item.

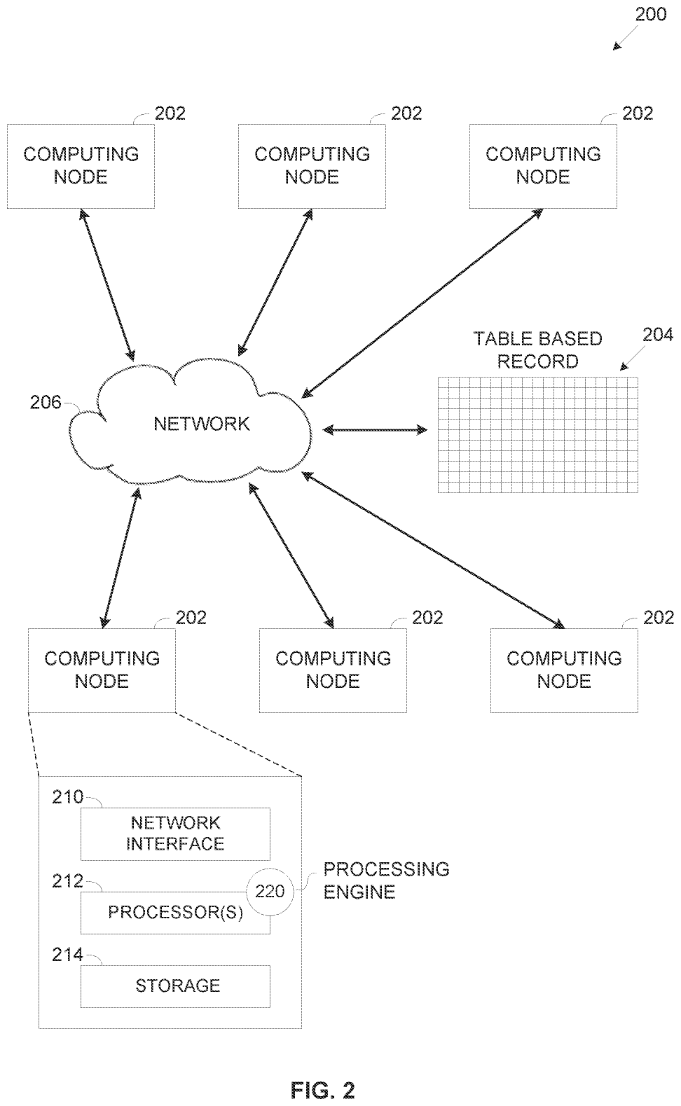

Reference is also made to FIG. 2, which is a schematic illustration of an exemplary system for efficiently retrieving data from a table comprising at least some private encrypted data using a plurality of computing nodes engaged in a secure MPC, according to some embodiments of the present invention.

An exemplary system 200 may include plurality of networked computing nodes 202, for example, a computer, a server, a processing node, a cluster of computing nodes and/or other processing devices comprising one or more processors. The computing nodes 202 may be configured to engage in one or more MPC sessions to search for matching private encrypted data items in one or more table based records 204.

The network computing nodes 202 may communicate with each other via a network 206 comprising one or more wired and/or wireless networks, for example, a Local Area Network (LAN), a Wireless LAN (WLAN), a Wide Area Network (WAN), a Municipal Area Network (MAN), a cellular network, the internet and/or the like.

Optionally, one or more of the computing nodes 204 are implemented, utilized and/or employed using one or more cloud based platforms, services and/or applications.

The table based record 204, for example, a database, a file, a list and/or the like may include a plurality of cells containing data items arranged in a plurality of rows and columns. Each of the columns may typically correspond to a respective one of a plurality of data properties such that an intersecting cell of each row may include a data item holding a value of the respective property.

The table based record 204 which is accessible to each of the computing nodes 202 may be deployed in one or more arrangements and/or deployments. For example, the table based record 204 may be stored in one or more networked resources connected to the network 206, for example, a server, a processing node, a cluster of processing nodes and/or the like connected to the network 206 and thus accessible by the computing nodes 204. In another example, the table based record 204 may be stored by one or more cloud based platforms, services and/or applications accessible by the computing nodes 204 via the network 206. In another example, each of the computing nodes 204 may store a local copy of the table based record 204. In another example, the table based record 204 may be stored in one or more of the computing nodes 204 which may enable the other computing nodes 202 to access the table based record 204.

At least some of the data stored in the table based record 204 may be private data, for example, personal information, sensitive data and/or the like. In order to securely store the private data items, each such data item may be encrypted by splitting each private data item to a plurality of shares which are each distributed to a respective one of the plurality of computing nodes 202 such that no single computing node 202 may have access to the private data items. Each of the computing nodes 202 may typically locally store its respective share of each encrypted data items.

The computing nodes 202 forming a networked community may be typically controlled by different parties, for example, private people, commercial entities (e.g. banks, stock exchanges, companies, organizations, etc.), institutions (e.g. regulatory agencies, government offices, etc.) and/or the like such that the computing nodes 204 are independent from each other. This may significantly reduce exposure of the computing nodes 204 to malicious attack and/or exploitation initiated in attempt to compromise the computing nodes 204, specifically in attempt to gain access to the private data stored in the table based record 204.

Each of the computing nodes 202 may include a network interface 210 for connecting to the network 208, a processor(s) 212 for executing the process 100 and a storage for storing data and code (program store).

The network interface 210 may include one or more wired and/or wireless network interfaces for connecting to the network 206, for example, a LAN interface, a WAN interface, a WLAN interface, a cellular interface and/or the like. Via the network interface 210, the computing nodes 202 may communicate with one or more networked resources connected to the network 206, for example, one or more of the other computing nodes 202.

The processor(s) 212, homogenous or heterogeneous, may include one or more processing nodes arranged for parallel processing, as clusters and/or as one or more multi core processor(s). The storage 214 may include one or more non-transitory non-volatile, persistent memory devices and/or arrays, for example, a ROM, a Flash array, a hard drive, an SSD, a magnetic disk and/or the like serving for data and/or program store. The storage 214 may also include one or more volatile memory devices and/or arrays, for example, a RAM device, a cache memory and/or the like serving for temporary storage of data and/or program store. The storage 214 may optionally include one or more networked storage resources, for example, a storage server, a Network Attached Storage (NAS) and/or the like.

The processor(s) 212 may execute one or more software modules such as, for example, a process, a script, an application, an agent, a utility, a tool, an Operating System (OS), a driver, a plug-in, a patch, an update and/or the like each comprising a plurality of program instructions stored in a non-transitory medium (program store) such as the storage 214 and executed by one or more processors such as the processor(s) 212. The processor(s) 212 may further include, utilize and/or facilitate one or more hardware modules (elements) integrated and/or coupled with the computing node 202, for example, a circuit, a component, an Integrated Circuit (IC), an Application Specific Integrated Circuit (ASIC), a Field Programmable Gate Array (FPGA), a Digital Signals Processor (DSP) and/or the like.

The processor(s) 212 of each of the computing nodes 202 may therefore execute one or more functional modules, for example, a processing engine 220 utilized by one or more software modules, one or more of the hardware modules and/or a combination thereof for executing the process 100.

In order to facilitate the secure MPC and ensure security and safety of data exchanged between the computing nodes 202 during the secure MPC sessions, the computing nodes 202 may establish private communication channel with each other.

The processor(s) 212 and/or the network interface 210 of each network computing node 202 may therefore execute, include and/or utilize one or more hardware and/or software modules to establish one or more secure communication channels with the other computing nodes 202.

For example, each of the computing nodes 202 may establish a secure private communication channel with each of the other computing nodes 204 by encrypting one or more messages exchanged between the computing nodes 202 and the other computing nodes 202. In particular, the computing node 202 may employ one or more private/public key cryptography (asymmetric cryptography) algorithms as known in the art for encrypting message data and further for authenticating the originator (sender) of the message.

Each of the computing nodes 202 may be assigned with a respective unique cryptographic key pair comprising a private key and a public key derived from the private key. The private key of each computing node 202 is locally and privately saved such that it is thus only known to the respective computing node 202 while the public keys of all of the computing node 202 are publicly distributed.

Using its private key and the public keys of the other computing nodes 202, each of the computing nodes 202 may establish a private secure communication channel with the respective other computing node 202 for both encrypting the exchanged data and for authenticating the originating computing node 202 of the data.

A first computing node 202 transmitting one or more messages to a second computing node 202 encrypt the message(s) using the public key of the second computing node 202. As such, these message(s) may be only decoded (decrypted) using the private key from which the public key was derived. Since the second computing node 202 is the only one having the appropriate private key, only the second computing node 202 may decode the received message(s) using its private key.

Moreover, in order to authenticate itself, the first computing node 202 may further encrypt one or more of the messages transmitted to the second computing node 202 using its private key. The second computing node 202 may use the public key of the first computing node 202, which is publicly available, to decode the message(s) thus verifying that the first computing node 202 is the origin of the message(s). Since only the first computing node 202 has the private key corresponding to the public key of the first computing node 202, only the first computing node 202 could have encrypted the message(s) using this private key and the first computing node 202 is thus deterministically authenticated.

As described herein before at least some data items stored in the table based record 204 may be private data. For example, the table based record 204 may store data relating to financial and/or trade transactions made by a plurality of users. In such case, a certain column corresponding, for example, to a user personal name property may include a plurality of cells containing data items holding the personal names of the users. Such user names may be private information and the data items contained in the cells of the certain column may be therefore encrypted. Other columns corresponding to other properties, for example, transaction amount, a transaction type (e.g. credit/debit), a transaction time and/or the like which may be regarded as non-private data. Therefore, the data items contained in the cells of these columns may typically not be encrypted. In another example, the table based record 204 may store data relating to an organization employees and/or clients. In such case, certain columns corresponding to, for example, client name, client budget and/or the like may include a plurality of cells containing respective data items which may be considered private information and may be therefore encrypted. Other columns corresponding to other properties, for example, a client organization size, a client market segment and/or the like which may be regarded as non-private data and may be therefore not encrypted.

In order to protect them, the private data items may be therefore encrypted, meaning that the content of the cells of one or more of the columns of the table based record 204 may be encrypted. In particular, the private data items may be encrypted by splitting each of the private data items to a plurality of shares distributed between the plurality of computing nodes 202 such that each of the computing nodes 202 has a respective share and is thus unable to individually reproduce the encrypted private data items. The encrypted private data items may be reconstructed (decoded) only by at least some of the plurality of computing nodes 202 which engage in a one or more secure

MPC sessions, each using its respective share as known in the art. This means that in the secure MPC session(s), the computing node 202 using one or more of the MPC algorithms and/or protocols as known in the art may be able to jointly decode one or more of the encrypted private data items while no single computing node 202 may access and/or recover any of the decoded (decrypted) data item(s).

Moreover, in order to support fast and efficient key matching as described herein after in detail, each of the private data items, which are encrypted and thus interchangeably designated encrypted data item herein after, may be first converted to a respective one-hot representation according to one or more bases. In the one-hot representation, as known in the art, a value may be represented by a single bit set (“1”) in only one of the positions of each digit while all other positions are cleared (“0”). The same one-hot representation is repeated in each power (digit).

The base used to create the one-hot representations of the encrypted data items may be defined, set and/or selected according to one or more criteria, conditions, and/or operational parameters. For example, the base selected for creating the one-hot representations of one or more of the encrypted data items may be decimal base. In another example, the base selected for creating the one-hot representations of one or more of the encrypted data items may be hexadecimal base. In another example, the base for creating the one-hot representations of one or more of the encrypted data items may be selected according to one or more operational parameters of the computing nodes 202. For example, the base may be selected and/or defined according to an Instruction Set Architecture (ISA) of the processor(s) 212 of the computing nodes 202, for example, 256, 65536 and/or the like.

Assuming the selected base is decimal. A one-hot representation of a certain value, for example, “2” may include a single bit set at the position corresponding to the value 2 in the first digit, i.e. the units row (10°) while all other positions in the units row are cleared. The decimal one-hot representation of the value “2” may further include a single bit set in the position corresponding to the value 0 in all other rows, i.e., tens (10¹), hundreds (10²), thousands (10³) and so on while all other positions in all of the other rows are cleared. The decimal one-hot representation of another exemplary value, for example, “154” may include a single bit set at the position corresponding to the value 4 in the units row (10⁰) while all other positions in the units row are cleared, a single bit set at the position corresponding to the value 5 in the second digit, i.e., the tens row (10¹) while all other positions in the tens row are cleared and a single bit set at the position corresponding to the value 1 in the third digit, i.e., the hundreds row (10²) while all other digit places in the hundreds row are cleared. Moreover, in the one-hot representation of the value “154”, a single bit is set at the position corresponding to the value 0 in all other rows, i.e., thousands (10³), tens of thousands (10⁴), hundreds of thousands (10⁵) and so on while all other positions in all of the other rows are cleared.

Assuming the selected base is hexadecimal. A one-hot representation of a certain value, for example, “12” (decimal value “12”) may include a single bit set at the position corresponding to the value 2 in the first digit, i.e. the first (units) row (16⁰), while all other positions in the first row are cleared and a single bit set at the position corresponding to the value 1 in the second digit, i.e., the second row (16¹) while all other positions in the second row are cleared. The hexadecimal one-hot representation of the value “12” may further include a single bit set in the position corresponding to the value 0 in all other rows, i.e., the third row (16²), the fourth row (16³), the fifth row (16⁴) and so on while all other positions in all of the other rows are cleared. The hexadecimal one-hot representation of another exemplary value, for example, “108” (decimal value “264”) may include a single bit set at the position corresponding to the value 8 in the first digit, i.e. the first (units) row (16⁰), while all other positions in the first row are cleared, a single bit set at the position corresponding to the value 0 in the second digit, i.e., the second row (16¹) while all other positions in the second row are cleared and a single bit set at the position corresponding to the value 1 in the third digit, i.e., the third row (16²) while all other positions in the third row are cleared. The hexadecimal one-hot representation of the value “108” may further include a single bit set in the position corresponding to the value 0 in all other rows, i.e., the fourth row (16³), the fifth row (16⁴), the sixth row (16⁵) and so on while all other positions in all of the other rows are cleared.

The size of the one-hot representation, i.e., the range of values that can be represented in one-hot representations which is expressed by the number of rows (number of powers) may be defined by one or more applicable parameters, for example, the range of the encrypted data items of the table based record 204 that need to be represented in respective one-hot representations, a capacity of the memory and/or storage where the table based record 204 is stored, for example, the memory 214 and/or the like.

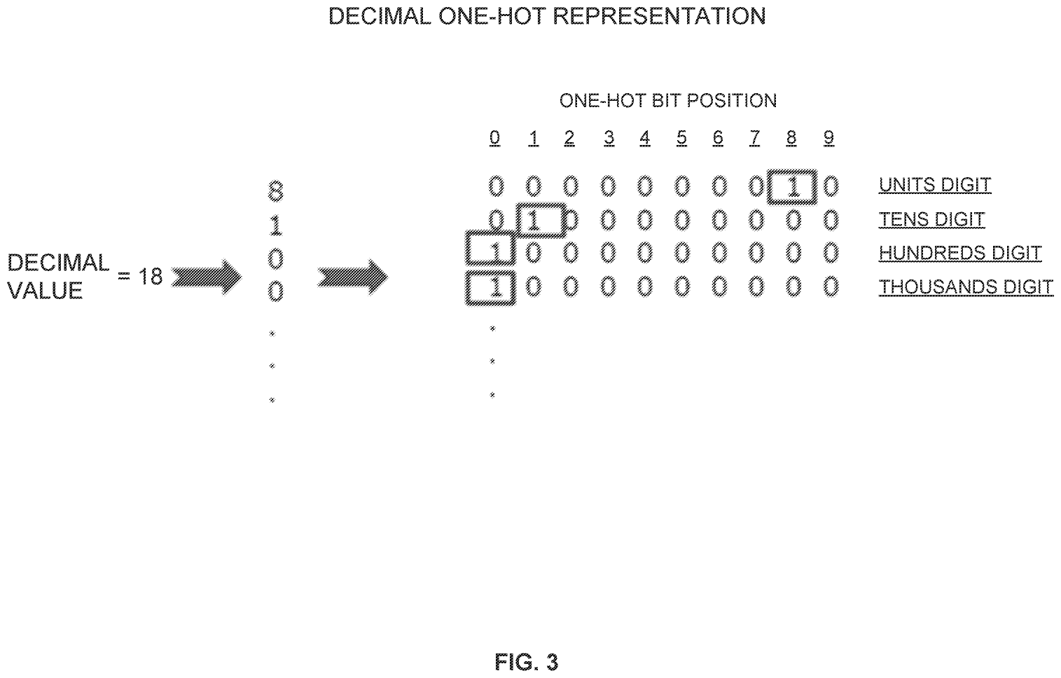

To more visually demonstrate the one-hot representation, reference is now made to FIG. 3, which is a schematic illustration of an exemplary one-hot representation of data values, according to some embodiments of the present invention.

One or more data items stored in one or more table based records 204 such as the table based record 204 may be represented by respective one-hot representations according to one or more bases, for example, the decimal base.

As seen, a decimal (decimal base) one-hot representation is created for an exemplary decimal value “18”. The value “18” is shown in a vertical arrangement where the top value is the units digit (10°) value “8”, next is the tens digit (10¹) value “1”, followed by the hundreds digit (10²) value “0” and the thousands digit (10³) value “0” and so one which are all set to “0”.

Next is a one-hot representation of the value “18”, specifically the one-hot representation of each digit of the value “18” which is expressed in a respective row corresponding to one of the digits of the value “18”. As seen, in the top row which corresponds to the units digit (10⁰), only the bit at the position corresponding to the value “8” is set while all of the other bits in the top row are cleared. In the next row (second from top) which corresponds to the tens digit (10¹), only the bit at the position corresponding to the value “1” is set while all of the other bits in this row are cleared.

In the next row (third from top) which corresponds to the hundreds digit (10²), only the bit at the position corresponding to the value “0” is set while all of the other bits in this row are cleared. In the next row (fourth from top) which corresponds to the thousands digit (10³), only the bit at the position corresponding to the value “0” is set while all of the other bits in this row are cleared. This may be repeated for as many digits (rows) defined for the one-hot representations of the encrypted data items.

Reference is made once again to FIG. 1 and FIG. 2.

As described herein before, in order to ensure privacy, security and/or safety of the private data items, each of the private data items, specifically the one-hot representation of each private data item may be encrypted by splitting (dividing) each one-hot representation to a plurality of shares which may be distributed to a plurality of the computing nodes 202. Specifically, the value, i.e., “1” or “0” of each position (bit) of each row (digit) of the one-hot representation of each private data item is encrypted by splitting it to a plurality of shares which are distributed among the plurality of computing nodes 202 such that the computing nodes 202 have direct access to the respective share of each position in the one-hot representation of each encrypted data item. The one-hot representing of each private data item is encrypted by the splitting using one or more encoding functions, for example, XOR, addition modulo 2n or 2ⁿ⁻¹ (where n is the size of the private data item's representation in bits) and/or the like.

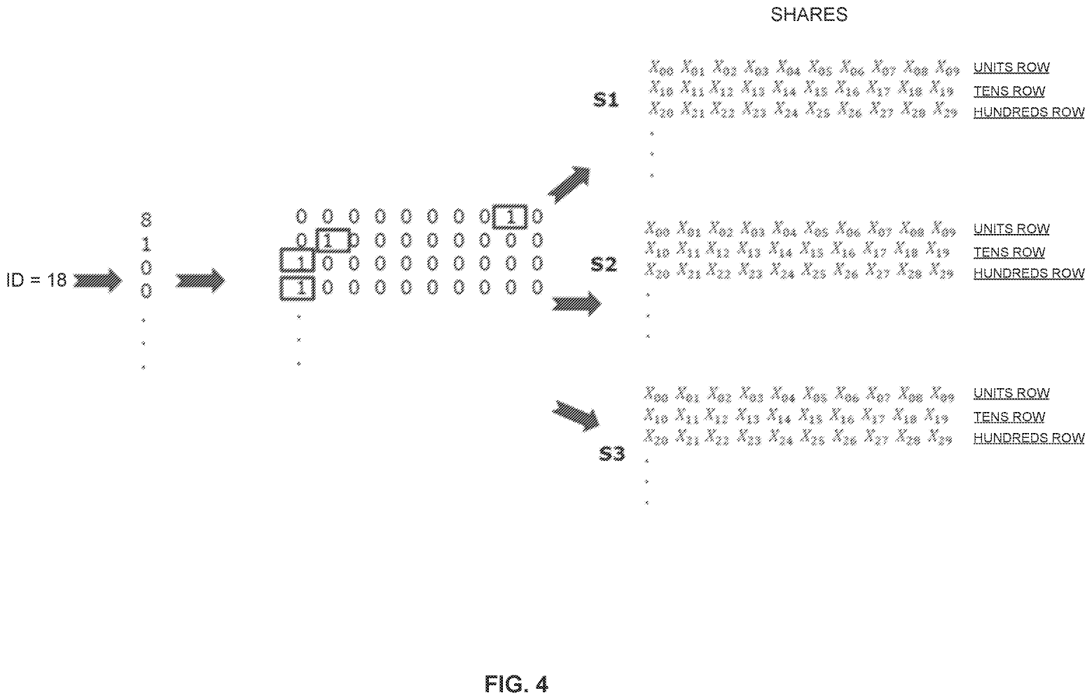

Reference is also made to FIG. 4, which is a schematic illustration of an exemplary one-hot representation of an exemplary data value split to a plurality of shares distributed to a plurality of networked computing nodes, according to some embodiments of the present invention.

Continuing the previous example, the decimal one-hot representation of the exemplary decimal value “18” may be split to a plurality of shares, for example, three shares, S1, S2 and S3 using one or more reconstruction functions. Each of the shares S1, S2 and S3 may include a plurality of shares Xᵢⱼ each corresponding to a respective one of the positions j in each of the rows i of the decimal one-hot representation of the value “18”. A set of corresponding shares Xᵢⱼ from the shares S1, S2 and S3 may therefore form the value of the corresponding bit position j in the rows i. For example, combining the share X₀₀ of the share S1, the share X₀₀ of the share S2 and share X₀₀ of the share S3 may form the value of the bit at position “0” of the row “0” (units row) which is “0”. In another example, combining the share X₀₈ of the share S1, the share X₀₈ of the share S2 and share X₀₈ of the share S3 may form the value of the bit at position “8” of the row “0” (units row) which is “1”.

In particular, the shares Xᵢⱼ of the shares S1, S2 and S3 may be created using one or more encoding functions to encrypt the decimal one-hot representation of the value “18” where each individual share is random. The encoding functions may include, for example, the XOR encoding function. In another example, the encoding function may be implemented by the addition modulo encoding function. As such, one or more respective decoding functions reversing the operation of the encoding function(s) may be applied to decode and reconstruct the value of the respective bit position of the respective row. For example, in case the encoding function used to create the shares was XOR, the decoding function used to reconstruct the bit values may be also XOR which is the inverse of XOR. In another example, assuming the addition modulo encoding function was used to create the shares, the decoding function used to reconstruct the bit values may be adding the shares together.

For example, applying the decoding function(s) to the share X₀₃ of the share S1, the share X₀₃ of the share S2 and share X₀₃ of the share S3 may form the value of the bit at position “3” of the row “0” (units row) which is “0”. In another example, applying the decoding function(s) to the share X₁₁ of the share S1, the share X₁₁ of the share S2 and share X₁₁ of the share S3 may form the value of the bit at position “1” of the row “1” (tens row) which is “1”.

Splitting the one-hot representations of the encrypted data items (private data items) to three shares as presented in FIG. 4 is exemplary and should not be construed as limiting since the one-hot representations of the encrypted data items may be split in a plurality of other schemes, practically to any number of shares as applicable and/or required.

Reference is made once again to FIG. 1.

The process 100 is described for searching and retrieving data of rows of the table based record 204 comprising an encrypted data item matching a queried data item serving as a match key. Specifically, the process 100 is described for receiving a single key data item targeting a certain column of encrypted data items in the table based record 204 and retrieving rows comprising matching encrypted data items in the certain column. This however should not be construed as limiting since the process 100 may be expanded to receive multiple queried data items serving as a match key in a plurality of columns.

As shown at 102, the process 100 starts with one or more of the computing nodes 202 receiving a query to retrieve data from the table based record 204. In particular, the query may comprise a data item serving as match key for searching for matching data items in the table based record 204, specifically to find matching encrypted data items stored a certain column of the table based record 204.

The queried data item (key) included in the query may potentially match one or more of the plurality of encrypted data items. The query is therefore directed to retrieve data included in rows of the table based record 204 which comprise encrypted data items matching the queried data item in the respective cells of the respective column(s) targeted by the queried data item. However, while the queried data item used as the match key targets the encrypted data items, the queried data item itself is received in decrypted form, i.e., not encrypted.

The table based record 204 may include data relating to a plurality of applications, for example, financial and/or trade transactions made by a plurality of users where at least some of the data is private data which is therefore encrypted and split between the plurality of computing nodes 202. The queried data item may include, for example, a name, an identifier and/or the like of a user, a trader, a client and/or the like which is private data encrypted and split in the table based record 204.

The computing nodes 202 may receive the query in one or more operation and/or implementation modes. For example, while it is possible that each of the computing nodes 202 may individually receive the query, optionally, only one or several of the computing nodes 202 serving as master computing nodes may receive the query and may propagate, i.e., transmit, deliver and/or otherwise, provide the query and/or part thereof to the rest of the computing nodes 202.

The computing node(s) 202 may receive the query and/or the queried data item from one or more systems, services and/or entities which are beyond the scope of this disclosure. Briefly stated, the query may be received from one or more management systems configured to manage access to the table based record 204, for example, a database management system and/or the like.

As shown at 104, a one-hot representation is generated for the queried data item (key) according to the same base used to create the one-hot representation of the encrypted data items in the table based record 204. Generating the one-hot representation or the queried data item is feasible since the queried data item is received in decrypted form and may be therefore converted to its respective one-hot representation according to the base applied in the table based record 204, for example, decimal base, hexadecimal base, the processor(s) 212 ISA based base and/or the like.

Generating the one-hot representation of the queried data item may be done by one or more of the computing nodes 202 according to the operation and/or implementation mode applied for distributing the query to the computing nodes 202. For example, in case the queried data item is received by each of computing nodes 202, each computing node 202 may convert the key data item to the one-hot representation. However, in case the queried data item is received only by the master computing node(s) 202, the master computing node(s) may create the one-hot representation for the key data item. The master computing node(s) 202 may optionally transmit the one-hot representation of the queried data item to the other computing nodes 202.

As shown at 106, the computing nodes 202 may engage in one or more MPC sessions to match between the one-hot representation of the queried data item and the encrypted one-hot representation of each of the plurality of encrypted (private) data items.

Specifically, the computing nodes 202 may use their respective shares of the encrypted one-hot representation of each encrypted data item to match between the one-hot representation of the queried data item and the one-hot representation of each encrypted data item. The match is based on multiplying the bit positions in the encrypted data items which are identified as hot bits (set bits) in the one-hot representation of the queried data item. In case the outcome of the multiplication is one (“1”) for a respective encrypted data item, the respective encrypted data item may match the queried data item since the bits of the of the one-hot representation of the respective encrypted data item at the positions identified as hot are all set (“1”).

However, in case even one of the bits in the one-hot representation of a respective encrypted data item at the positions identified as hot is cleared (“0”), the multiplication outcome may be zero (“0”) thus indicating that the respective encrypted data item does not match the queried data item.

To this end, the hot bits, i.e., the bits which are set in the one-hot representation of the queried data item may be first identified. Again, identifying the set bits may be done by one or more of the computing nodes 202 according to the operation and/or implementation mode applied for distributing the query to the computing nodes 202. For example, in case the queried data item is received by each of computing nodes 202, each computing node 202 may identify the hot bits in the one-hot representation it created for the queried data item. In case the queried data item is received only by the master computing node(s) 202, the master computing node(s) may identify the hot bits in the one-hot representation of the queried (key) data item and may transmit to the other computing nodes 202 an indication (e.g. identifier) of the position of each hot bit identified in the queried data item.

The plurality of computing nodes 202 may then engage in an MPC session to jointly multiply all the bits in the encrypted one-hot representation of each of the encrypted data items in the certain column of the table based record 204 in the positions identified to include hot bits in the one-hot representation of the queried data item.

The computing nodes 202 may employ one or more MPC algorithms and/or protocols as known in the art to engage in the secure MPC session. In particular, the secure MPC session may be executed by the computing nodes 202 using one or more MPC protocols which are based on one or more secret sharing algorithms, for example,

Shamir's secret sharing algorithm, a multiple signature protocol such as, for example, multisig (multi-signature) and/or the like. The secret sharing algorithm(s) may be initially used to split the one-hot representation of each of the encrypted data items to create the shares which are distributed to the plurality of computing nodes 202 such that each of the computing nodes 202 has access only to a respective one of the shares and not to any entire encrypted data item.

Optionally, one or more of the MPC protocol(s) used by the computing nodes 202 to engage in the secure MPC session to reconstruct the encrypted one-hot representations of the encrypted data items and multiply their bits in the hot positions may include one or more threshold MPC protocols, for example, threshold secret sharing algorithm, threshold multi-signature protocol and/or the like. Such threshold MPC protocol(s) may define that only a subset of the plurality of computing nodes 202 is sufficient to engage in the secure MPC session and successfully reconstruct the encrypted one-hot representations of the encrypted data items and multiply their bits in the hot positions without the need for all of the computing nodes 202 to participate in the secure MPC session(s).

A subset of m computing nodes 202 out of the plurality of n computing nodes 202 (2≤m≤n) may therefore engage in the secure MPC session(s) and using their respective shares of the encrypted one-hot representations of the encrypted data items, may reconstruct the encrypted one-hot representations of the encrypted data items and multiply their bits in the hot positions to determine whether one or more of the encrypted data items match (equals) the queried data item.

The sufficient number m of computing nodes 202 which is sufficient to may be defined by the MPC protocol(s) used by the computing nodes 202 to engage in the secure MPC session(s). For example, assuming there are ten computing nodes 202, i.e., n=10, the MPC protocol used by the computing nodes 202, for example, Shamir's secret sharing algorithm may define that a subset comprising any 7 (m=7) computing nodes 202 out of the total of ten computing nodes 202 is sufficient to reconstruct the encrypted one-hot representations of the encrypted data items and multiply their bits in the hot positions.

As described herein before, in case the mutilation result is “1” for an encrypted one-hot representation of a certain encrypted data item, the certain encrypted data item matches the queried data item. In contrast, in case the mutilation result is “0” for the encrypted one-hot representation of the certain encrypted data item, the certain encrypted data item does not match the queried data item.

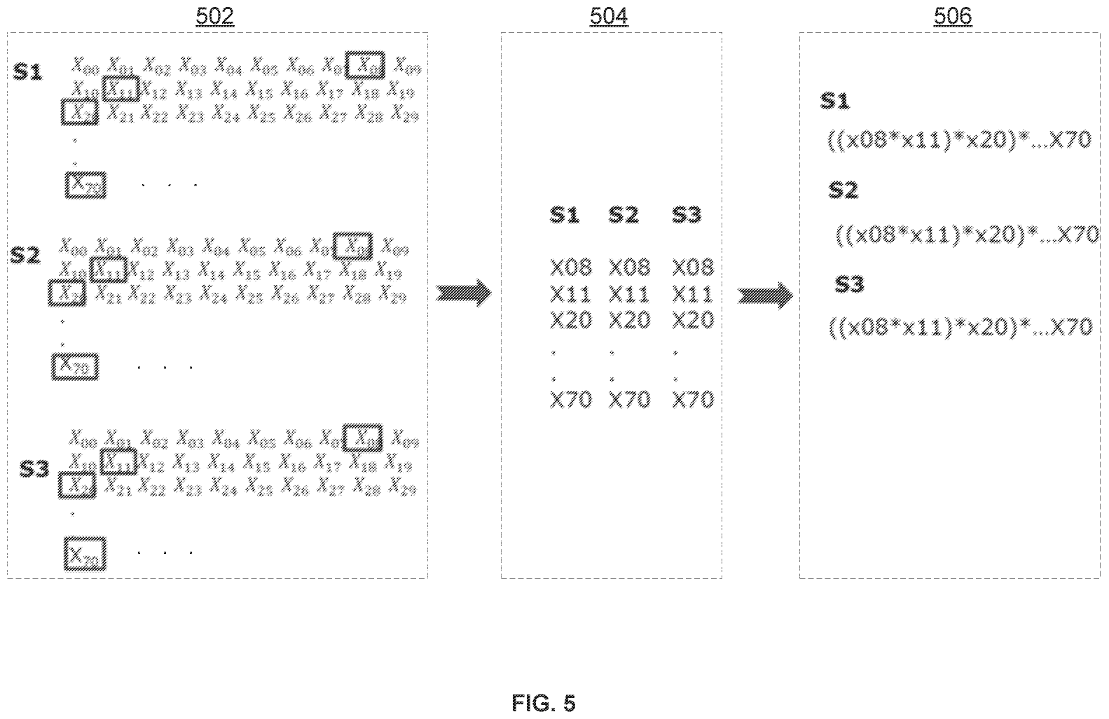

Reference is now made to FIG. 5, which is a schematic illustration of a sequence for multiplying hot bits of an exemplary one-hot representation for matching an encrypted one-hot representation of a data value by a plurality of networked computing nodes such as the computing nodes 202 using their respective shares, according to some embodiments of the present invention.

To continue the previous example, assuming the table based record 204 contains data relating to financial and/or trading transactions of a plurality of clients, users and/or traders, the queried data item may include an identifier, for example, “18” (decimal value) of a certain client, user and/or trader.

After generating the one-hot representing of the queried data item, i.e., of the decimal value “18”, the plurality of computing nodes 202 may identify the bit positions in the one-hot representing of the queried data item which contain hot bits, i.e., set bits (bits set to “1”). To continue the previous example, the plurality of computing nodes 202 may include three computing nodes 202 each storing a respective one of the shares S1, S2, and S3 of each of the plurality of encrypted data items of a column in the table based record 204 comprising the identifiers of the clients, users and/or traders.

The three computing nodes 202 may therefore engage in the MPC session to multiply the bits in the encrypted data items which are located at the positions identified in the one-hot representing of the queried data item to include set bits. In particular, assuming each identifier in the table based record 504 is represented by a respective decimal base one-hot representation consisting of 80 bits, the set bits for the identifier “18” are X₀₈, X₁₁, X₂₀, X₃₀, X₄₀, X₅₀, X₆₀ and X₇₀ as seen at 502. The three computing nodes 202 may engage in the MPC session to reconstruct the encrypted one-hot representation of each encrypted data item using their respective shares S1, S2, and S3 as seen at 504. As seen at 506, the three computing nodes 202 may further multiply the bits of each encrypted data item, specifically of the encrypted one-hot representation of each of the encrypted data items.

The value of each encrypted data item for which the outcome of the multiplication of these bits in its respective encrypted one-hot representation is “1” is “18” and therefore matches the queried data item “18”. However, the value of each encrypted data item for which the outcome of the multiplication of these bits in its respective encrypted one-hot representation is “0” is not “18” and therefore does not match the queried data item “18”.

Optionally, the computing nodes 202 may engage in the MPC session to simultaneously multiply pairs of bits in the encrypted one-hot representation of one or more of the encrypted data item such that a plurality of pairs of bits are multiplied and computed in parallel. Specifically, the computing nodes 202 may simultaneously multiply pairs of bits in the encrypted one-hot representation of the encrypted data item(s) which are located at positions identified to include hot bits (bits set to “1”) in the one-hot representation of the queried data item. This is possible due to the fact that the multiplication operation for each pair of bits in the one-hot representation of each of the encrypted data items is independent of the multiplication operation done for any other pair of bits in the one-hot representation.

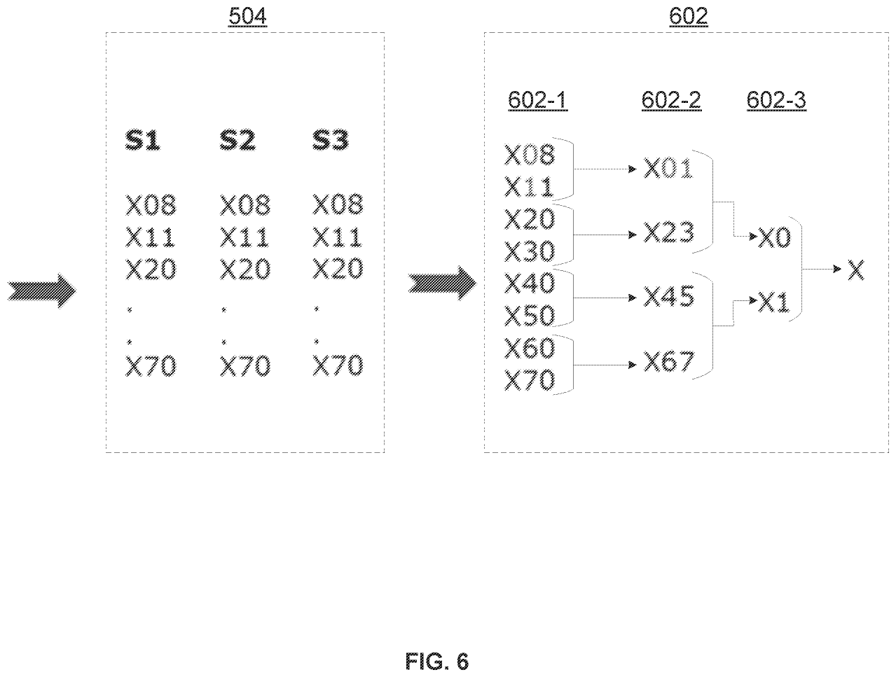

Reference is now made to FIG. 6, which is a schematic illustration of a sequence for simultaneously multiplying hot bits of an exemplary one-hot representation for matching an encrypted one-hot representation of a data value by a plurality of networked computing nodes using their respective shares, according to some embodiments of the present invention.

Continuing the previous example, where each identifier in a table based record such as the table based record 504 is represented by a respective decimal base one-hot representation consisting of 80 bits, the set bits for the identifier “18” are X₀₈, X₁₁, X₂₀, X₃₀, X₄₀, X₅₀, X₆₀ and X₇₀. As described herein before for 504 in FIG. 5, the three computing nodes 202 may engage in the MPC session to reconstruct the encrypted one-hot representation of each encrypted data item using their respective shares S1, S2, and S3.

However, instead of serially multiplying the bits in the hot bit positions of each one-hot representation of each encrypted data item as seen in 506, as seen at 602, the three computing nodes 202 may simultaneously multiply pairs of bits at the hot positions in parallel and may gradually multiply the outcomes of each multiplication stage to reach a final result. For example, for the exemplary value “18” where the hot positions are X₀₈, X₁₁, X₂₀, X₃₀, X₄₀, X₅₀, X₆₀ and X₇₀, at a first stage 602-1 the three computing nodes 202 may multiply in parallel four pairs of bits in the one-hot representation of each of the decrypted data items, for example, X₀₈·X₁₁, X₂₀·X₃₀, X₄₀·X₅₀ and X₆₀·X₇₀. At a second stage, 602-2, the three computing nodes 202 may multiply in parallel two pairs of results of the first stage 602-1, for example, X₀₁·X₂₃ and X₄₅·X₆₇ where X₀₁ stands for the outcome of X₀₈·X₁₁, X₂₃ stands for the outcome of X₂₀·X₃₀, X₄₅ stands for the outcome of X₄₀·X₅₀ and X₆₇ stands for the outcome of X₆₀·X₇₀. At a third stage, 602-3, the three computing nodes 202 may multiply the results of the second stage 602-2, X₀·X₁, where X₀ stands for the outcome of X₀₁·X₂₃ and X₁ stands for the outcome of X₄₅·X₆₇, to produce a final result X of the multiplication.

Optionally, the rows of the table based record 204 may be sorted according to values of non-encrypted data items contained in one or more of the columns of the table based record 204 since sorting of the rows according to non-encrypted data items in one column has no impact on the matching between the encrypted data items in another column with the queried data item. For example, assuming the matching is done according to the identifier of the clients, users and/or trader which are encrypted in a certain column of the table based record 204, at least some of the rows of the table based record 204 may be sorted according to the non-encrypted values of another column, for example, a transaction time, a transaction monetary value and/or the like.

The sorting may be applied according to one or more techniques, methods and/or algorithms as known in the art. For example, the sorting may be done may be done using one or more filters applied to one or more properties (columns) of the table based record 204 according to bucket filtering and sorting which may be expressed, for example, by equation 1 below. Equation 1 may be applied, for example, to a table based record 204 containing trading information and comprising private data items, for example, traders' IDs (designated client_id in equation 1).

BucketSort[real_table[index][real_client_id]]+=if_finder_result[index]

uniqueSum=Σᵢ₌₀ⁿ1 if BucketSort[i]>0 else 0 Equation 1:

Where:
index is the current index ranging over the table based record 204,
if_finder_result[index] is the result of the secure MPC filter applied to the table based record 204 (typically 0 or 1),
real_table is the original table based record 204,
eal_table [index] is the current row,
[real_table[index][real_client_id]] is a specific (non-private) column of the current row,
BucketSort is an array containing, for each value of the non-private column real_client_id, a count of the filtered results with this value, and
uniqueSum is the number of non-zero entries indicative of how many clients (traders) passed the filter.

Reference is made once again to FIG. 1.

As shown at 108, one or more of the computing nodes 202 may output an indication of each row comprising a matching encrypted data item in the certain column which matches the queried data item. Specifically, each matching row which is a row that includes, at the certain column, a respective encrypted data item for which the multiplication outcome is “1” may be indicated.

Indicating the matching rows may include, for example, outputting the data contained in each matching row and/or part thereof. In another example, the matching rows may include outputting an identifier, for example, a row number of each matching row.

The indication may be output by a single computing node 202, for example, the master computing node 202 or by multiple computing nodes 202 optionally by all of the computing nodes 202.

According to some embodiments of the present invention, the query for retrieving data from the table based record 204 may include one or more encrypted queried data items serving as key(s) to search for matching encrypted data items in one or more of the columns of the table based record 204. In particular, the query may include one or more encrypted one-hot representations of the queried data items.

At least some of the plurality of computing nodes 202 may engage in one or more secure MPC sessions to match the encrypted one-hot representation of the queried data item(s) to the encrypted one-hot representation of the private encrypted data stored in the table based record 204 and may output an indication, for example, the identifier of each matching row comprising private encrypted data item(s) matching the queried data item(s).

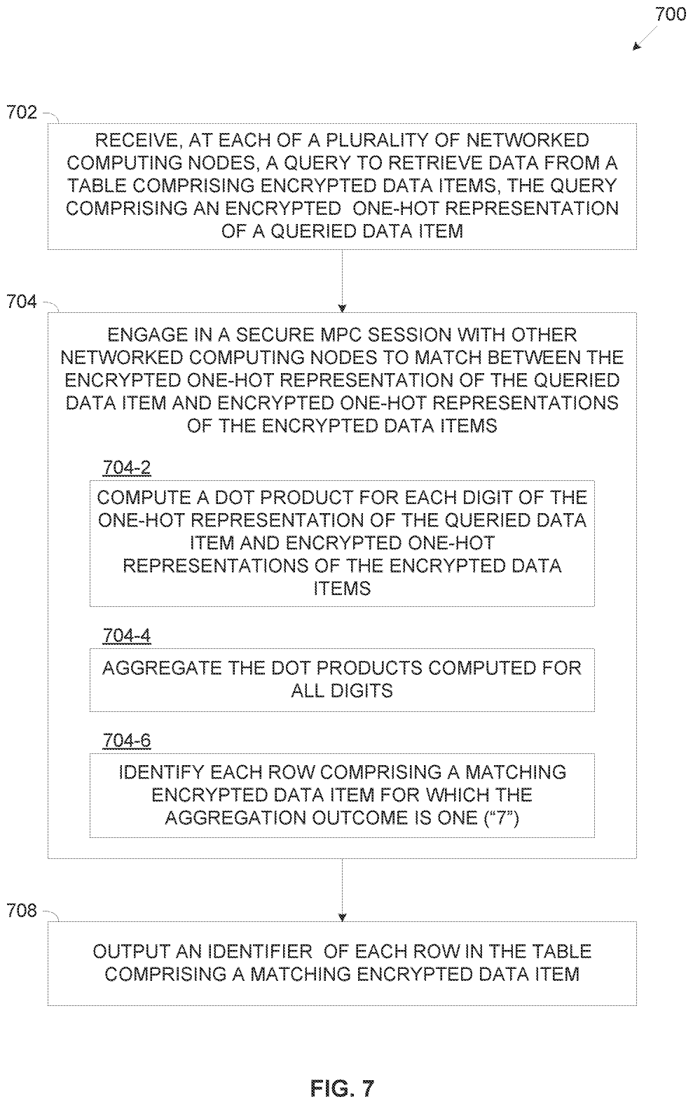

Reference is now made to FIG. 7, which is a flowchart of an exemplary process of efficiently retrieving data from a table comprising at least some private encrypted data using a plurality of computing nodes engaged in a secure MPC according to an encrypted queried data item, according to some embodiments of the present invention.

An exemplary process 700 may be executed by each of a plurality of networked computing nodes such as the networked computing nodes 202 for retrieving data from a table based record such as the table based record 204. In particular, the computing nodes 202 may receive a query comprising one or more encrypted queried data items serving as keys targeting one or more columns of the table based record 204 and matching respective encrypted data items in the table based record 04 to identify and retrieve matching rows comprising matching encrypted data items in the targeted column(s).

While the process 700 is described for receiving a single key data item targeting a certain column of encrypted data items in the table based record 204 and retrieving rows comprising matching encrypted data items in the certain column, this should not be construed as limiting since the process 700 may be expanded to receive multiple encrypted queried data items serving as match keys in a plurality of columns.

As shown at 702, the process 700 starts with one or more of the computing nodes 202 receiving a query to retrieve data from the table based record 204. The query may comprise an encrypted data item serving as match key for searching for matching data items in the table based record 204, specifically to find matching encrypted data items stored a certain column of the table based record 204.

As described in step 102 for non-encrypted queried data item (key) included in the query, the encrypted queried data item too may potentially match one or more of the plurality of encrypted data items. The query is therefore directed to retrieve data included in rows of the table based record 204 which comprise encrypted data items matching the encrypted queried data item in the respective cells of the respective column(s) targeted by the encrypted queried data item.

In particular, the encrypted data item included in the query may be an encrypted one-hot representation of the encrypted queried data item. Moreover, the encrypted one-hot representation may be compatible with the encrypted one-hot representations of the encrypted data items stored in the table based record 204, for example, expressed in the same base, have the same size, i.e., expressed in the same range and/or the like.

The computing nodes 202 may receive the query in one or more of the operation and/or implementation modes described in step 102 of the process 100.

As shown at 704, the computing nodes 202 may engage in one or more MPC sessions to match between the encrypted one-hot representation of the queried data item and the encrypted one-hot representation of each of the plurality of encrypted (private) data items in the column targeted by the query.

The matching conducted by the computing nodes 202 engaged in the secure MPC session(s) directed to identify each row which comprises an encrypted one-hot representation of the encrypted data item in the column targeted by the query may be done in a several sub-steps 702-2, 704-4 and 704-6.

As shown at 704-2, the computing nodes 202 may first traverse each of the plurality of digits of the encrypted one-hot representation of the queried data item and the respective digit in the encrypted one-hot representation of each encrypted data item in the table based record 204 to compute a dot product for each of the digits.

Specifically, the computing nodes 202 may compute the dot product for each digit of each encrypted data item by (1) multiplying the bits of each position of the respective digit in the encrypted one-hot representation of the queried data item and the respective bits in each position of the respective digit in the encrypted one-hot representation of the respective encrypted data item and (2) aggregating the outcomes of all bit multiplications.

Illustrated in further detail, the computing nodes 202 may multiply the bit in position 0 of the first digit in the encrypted one-hot representation of the queried data item with the bit in position 0 of the first digit in the encrypted one-hot representation of the respective encrypted data item. The computing nodes 202 may multiply the bit in position 1 of the first digit in the encrypted one-hot representation of the queried data item with the bit in position 1 of the first digit in the encrypted one-hot representation of the respective encrypted data item. The computing nodes 202 may further repeat this process for all bits of the first digit of the encrypted one-hot representations.

In particular, all bits of each digit of the encrypted one-hot representation of the queried data item may be arranged in a first sequence, for example, a long integer value (e.g. for base 64). Similarly, all bits of the respective digit in the encrypted one-hot representation of the respective encrypted data item may be arranged in a second sequence constructed as the first sequence. The computing nodes 202 may then apply a single AND operation between the first sequence and the second sequence to compute the dot product of the respective digit thus significantly reducing the computation time and thus the overall match time.

The computing nodes 202 may then aggregate, for example, sum, add, combine and/or the like the outcomes (results) of all the multiplications of all the bits in the first digit of the encrypted one-hot representations to produce the dot product for the first digit of the respective encrypted data item.

The computing nodes 202 may repeat this process for each of the digits of the encrypted one-hot representations of the encrypted queried data item and the encrypted one-hot representation of the respective encrypted data item to produce the dot product for the respective encrypted data item.

As shown at 704-4, the computing nodes 202 may aggregate the dot products computed for all of the digits for the encrypted one-hot representation of the respective encrypted data item.

As shown at 704-6, the computing nodes 202 may identify and determine whether the encrypted one-hot representation of the respective encrypted data item matches the encrypted one-hot representations of the encrypted queried data item. In particular, in case the outcome of the aggregated dot products is one (“1”), the one-hot representation of the respective encrypted data item matches the encrypted one-hot representations of the encrypted queried data item. However, in case the outcome of the aggregated dot products is zero (“0”), the one-hot representation of the respective encrypted data item does not match the encrypted one-hot representations of the encrypted queried data item.

The computing nodes 202 may repeat the steps 704-2, 704-4 and 704-6 for each of the encrypted data items contained in each of the rows of the table based record 204 in the targeted column to identify each matching row comprising a matching encrypted data item in the certain column which matches the encrypted queried data item.

As shown at 706, one or more of the computing nodes 202 may output an indication of each matching row. The computing nodes 202 may output the indication as described in step 108 of the process 100.

Optionally, only a subset of the computing nodes 202 may engage in the secure MPC session(s) to find matching rows in the table based record 204 and retrieve data from the matching rows. In particular, the secure MPC session may be conducted by a subset of the plurality of computing nodes 202 comprising a sufficient number of computing nodes 202 for matching the encrypted queried data item using their respective shares. To this end the subset of computing nodes 202 may engage in the secure MPC session using one or more of the threshold MPC protocols which may define the number of computing nodes 202 that is sufficient to engage in the secure MPC session and successfully match between the encrypted one-hot representation of the queried data item and encrypted one-hot representations of the encrypted data items.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms MPC protocol and secure channel and asymmetric key cryptography are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of efficiently retrieving data from an at least partially encrypted table based record using secure Multi-Party Computation (MPC), comprising:
using a plurality of networked computing nodes each comprising at least one processor configured for:
receiving a query to retrieve data from a table based record comprising a plurality of data items arranged in a plurality of rows and a plurality of columns, at least one of the plurality of columns containing a plurality of encrypted data items, the query comprising a data item, in decrypted form, which potentially matches at least one of the plurality of encrypted data items,
engaging in a secure MPC session with at least some of the plurality of networked computing nodes, each having a respective one of a plurality of shares of a one-hot representation of each of the encrypted data items, to match between a one-hot representation of the queried data item and the one-hot representation of each encrypted data item, and
outputting an identifier of each row comprising a matching encrypted data item;
wherein the MPC match is based on multiplying, in the one-hot representation of each encrypted data item, only bits which are identified as hot bits in the one-hot representation of the queried data item thus significantly reducing the match time.

2. The method of claim 1, wherein for each encrypted data item, a multiplication outcome of “one” (“1”) indicates the respective encrypted data item matches the queried data item and a multiplication outcome of “zero” (“0”) indicates the respective encrypted data item does not match the queried data item.

3. The method of claim 1, further comprising simultaneously multiplying respective pairs of bits in the one-hot representation of at least one encrypted data item.

4. The method of claim 1, further comprising sorting the rows according to values of non-encrypted data items contained in at least one of the plurality of columns.

5. The method of claim 1, wherein the one-hot representation is based on a decimal representation of the respective data item.

6. The method of claim 1, wherein the one-hot representation is based on a hexadecimal representation of the respective data item.

7. The method of claim 1, wherein the one-hot representation is set according to a word size defined by an instruction set architecture of the at least one processor.

8. The method of claim 1, wherein the secure MPC session is executed over secure communication channels established between the at least some networked computing nodes.

9. The method of claim 8, wherein the secure communication channels are established using at least one encryption protocol used for encrypting the data exchanged between the at least some networked computing nodes.

10. The method of claim 1, wherein the plurality of networked computing nodes are independent of each other such that each of the plurality of networked computing nodes is controlled by a respective party.

11. The method of claim 1, wherein the secure MPC session is executed by the plurality of networked computing nodes according to at least one MPC protocol based on at least one secret sharing algorithm used to create the plurality of shares of the one-hot representation of each of the encrypted data items.

12. The method of claim 11, further comprising the at least one MPC protocol defines a subset of the plurality of networked computing nodes comprising a sufficient number of networked computing nodes for matching the queried data item using their respective shares.

13. A system for efficiently retrieving data from an at least partially encrypted table based record using secure Multi-Party Computation (MPC), comprising:
a plurality of networked computing nodes, each of the plurality of networked computing nodes comprising at least one processor, the at least one processor is configured to execute a code, the code comprising:
code instructions to receive a query to retrieve data from a table based record comprising a plurality of data items arranged in a plurality of rows and a plurality of columns, at least one of the plurality of columns containing a plurality of encrypted data items, the query comprising a data item, in decrypted form, which potentially matches at least one of the plurality of encrypted data items,
code instructions to engage in a secure MPC session with at least some of the plurality of networked computing nodes, each having a respective one of a plurality of shares of a one-hot representation of each of the encrypted data items, to match between a one-hot representation of the queried data item and the one-hot representation of each encrypted data item, and
code instructions to output an identifier of each row comprising a matching encrypted data item;
wherein the MPC match is based on multiplying in the one-hot representation of each encrypted data item only bits which are identified as hot bits in the one-hot representation of the queried data item thus significantly reducing the match time.

14. A computer program product comprising program instructions executable by a computer, which, when executed by the computer, cause the computer to perform a method according to claim 1.

15. A method of efficiently retrieving data from an at least partially encrypted table based record using secure Multi-Party Computation (MPC), comprising:
using a plurality of networked computing nodes each comprising at least one processor configured for:
receiving a query to retrieve data from a table based record comprising a plurality of data items arranged in a plurality of rows and a plurality of columns, at least one of the plurality of columns containing a plurality of encrypted data items, the query comprising an encrypted one-hot representation of a queried data item which potentially matches at least one of the plurality of encrypted data items;
engaging in a secure MPC session with at least some of the plurality of networked computing nodes, each having a respective one of a plurality of shares of an encrypted one-hot representation of each of the encrypted data items, to match between the encrypted one-hot representation of the queried data item and the encrypted one-hot representation of each encrypted data item by:
computing a dot product for each of a plurality of digits of the encrypted one-hot representation of the queried data item and the encrypted one-hot representation of each encrypted data item,
aggregating the dot products computed for the plurality of digits, and
identifying each row comprising a matching encrypted data item for which an outcome of the aggregation is “one” (“1”); and
outputting an identifier of each matching row;
wherein computing the dot product is based on arranging all bits of the encrypted one-hot representation of the queried data item in a first sequence and the arranging all bits of the encrypted one-hot representation of each encrypted data item in a respective second sequence and applying a single AND operation between the first sequence and each second sequence thus significantly reducing the match time.

16. The method of claim 15, wherein the dot product is computed for each digit of each encrypted data item by multiplying respective bits of the respective digit in the encrypted one-hot representation of the queried data item and the respective bits in the encrypted one-hot representation of the respective encrypted data item.

17. The method of claim 15, further comprising the secure MPC session is conducted by a subset of the plurality of networked computing nodes comprising a sufficient number of networked computing nodes for matching the encrypted queried data item using their respective shares.

18. A system for efficiently retrieving data from an at least partially encrypted table based record using secure Multi-Party Computation (MPC), comprising:
a plurality of networked computing nodes, each of the plurality of networked computing nodes comprising at least one processor, the at least one processor is configured to execute a code, the code comprising:
code instructions to receive a query to retrieve data from a table based record comprising a plurality of data items arranged in a plurality of rows and a plurality of columns, at least one of the plurality of columns containing a plurality of encrypted data items, the query comprising an encrypted one-hot representation of a queried data item which potentially matches at least one of the plurality of encrypted data items,
code instructions to engage in a secure MPC session with at least some of the plurality of networked computing nodes, each having a respective one of a plurality of shares of an encrypted one-hot representation of each of the encrypted data items, to match between the encrypted one-hot representation of the queried data item and the encrypted one-hot representation of each encrypted data item by:
computing a dot product for each of a plurality of digits of the encrypted one-hot representation of the queried data item and the encrypted one-hot representation of each encrypted data item,
aggregating the dot products computed for the plurality of digits, and
identifying each row comprising a matching encrypted data item for which an outcome of the aggregation is “one” (“1”); and
code instructions to output an identifier of an identifier of each matching row;
wherein computing the dot product is based on arranging all bits of the encrypted one-hot representation of the queried data item in a first sequence and the arranging all bits of the encrypted one-hot representation of each encrypted data item in a respective second sequence and applying a single AND operation between the first sequence and each second sequence thus significantly reducing the match time.

19. A computer program product comprising program instructions executable by a computer, which, when executed by the computer, cause the computer to perform a method according to claim 15.
